(19) United States
(12) Patent Application Publication
(10) Pub. No.: US 2025/0299202 A1
(43) Pub. Date: Sep. 25, 2025

(54) SYSTEMS AND METHODS FOR EVALUATING INTERFACE CONTENT USING A MACHINE LEARNING FRAMEWORK

(71) Applicant: Wells Fargo Bank, N.A., San Francisco, CA (US)

(72) Inventors: Ramesh Yarlagadda, Charlotte, NC (US); Sarah W. Phelps, Annapolis, MD (US); Ravi K. Maganti, Eden Praire, MN (US); John Andrew Chuprevich, Davidson, NC (US); Bradford A. Shea, Mint Hill, NC (US); Agus Sudjianto, Charlotte, NC (US); Nick Maiorana, Charlotte, NC (US)

(21) Appl. No.: 18/611,356

(22) Filed: Mar. 20, 2024

(51) Int. Cl. G06Q 30/018

(52) U.S. Cl. CPC G06Q 30/018

(57) ABSTRACT

Systems, apparatuses, methods, and computer program products are disclosed for evaluating interface content for a user population. An example method includes receiving the interface content comprising one or more interface content components. The example method further include determining a user population of interest and selecting an evaluation model framework based on the user population of interest. The example method further includes determining an accessibility score for the interface content based on the one or more interface content components using the evaluation model framework and determining whether the accessibility score satisfies an accessibility score threshold. The example method further includes providing an interface content evaluation report.

### BACKGROUND

Electronic and information technology may be subject to compliance standards. For example, the American with Disabilities Act (ADA) requires that digital technology be accessible to individuals with disabilities. Additionally, the Web Content Accessibility Guidelines (WCAG) defines technical standards for web accessibility and has been used as guidelines for determining ADA compliance of digital and/or online content.

### BRIEF SUMMARY

As mentioned above, online content is subject to compliance standards such as WCAG. The ADA has used WCAG as a guideline for evaluating ADA compliance of web design and online content. Non-compliance to digital accessibility standards may expose an organization or entity to legal processing under the ADA, potentially leading to substantial fines and harm to the organization's reputation. Thus, it is imperative for organizations to generate and provide online content that is accessible to all users.

Although WCAG has laid a foundation for online content accessibility, these guidelines are rigid and fail to take into account individual accessibility preferences of a user. WCAG additionally does fully address the needs of all individuals with disabilities. For example, WCAG currently has limited guidelines for users with cognitive disabilities. Additionally, even WCAG guidelines for more robustly covered areas, such as visual or hearing impairments, still fail to consider individual preferences of users that may have varying levels of visual and/or hearing impairments. Furthermore, WCAG is primarily designed for web content such that it fails to address other technology platforms, such as native mobile applications or desktop applications.

In contrast to evaluating the accessibility of online content using conventional WCAG standards, example embodiments described herein allow for the evaluation of interface content in a manner that considers the wide-ranging accessibility preferences amongst different user populations. As such, example embodiments described herein do away with the conventional one-size-fits-all approach of conventional standards and allow for the evaluation of interface content that is responsive to inferred user population preferences. Furthermore, example embodiments described herein contemplate evaluating interface content for various technology platforms (e.g., web content, native mobile applications, desktop applications, etc.). In this way, the interface content may be evaluated based on user experience within different platforms.

Accordingly, the present disclosure sets forth systems, methods, and apparatuses that evaluate interface content for one or more user populations. In doing so, example embodiments described herein allow for the identification or detection of interface content and/or individual interface content components for their impact on various user populations. As will be appreciated, different user populations may experience interface content or even interface content components differently and while certain interface content may be accessible for one user population, a different user population may experience accessibility issues. By evaluating interface content for various user populations, example embodiments described herein allow for accessibility issues to be detected and thereby foster inclusivity and enhance user experience for users who may experience difficulties interacting with conventional interface content. Furthermore, example embodiments described herein may aid in enhancing any user's experience with interface content, not only users that experience difficulties or disabilities, as interface content is also evaluated for particular technology platforms.

Example embodiments described herein may receive interface content and determine platforms of interest and user populations of interest. An evaluation model framework that corresponds to a selected user population of interest may be selected and used to determine one or more sub-accessibility scores for interface content components that make up the interface content. Furthermore, the evaluation model framework may determine an accessibility score for the interface content for the population of interest. The accessibility score and sub-accessibility scores for one or more user populations of interest may be included in an interface content evaluation report, which may be provided to one or more end users for review. Users may use the interface content evaluation report to identify any accessibility issues of the interface content or interface content components for the one or more user populations of interest.

The evaluation model framework may include a rendering model, a user population model, a baseline model, and a scoring model, that may work in tandem to determine the accessibility score and one or more sub-accessibility scores for interface content and/or interface content components. The models included in the evaluation model framework may leverage machine-learning and/or deep learning techniques to evaluate interface content components and/or interface contents in a manner that is considerate of how the interface content components and/or interface content is perceived by a given user population. In particular, the user population model may be trained to emulate a particular user population and a baseline model may serve as a comparative, baseline population. That is, the user population model may be trained to process interface content components in a manner that emulates how these interface content components would be experienced by the user population of interest. The baseline population model may serve as a baseline for how a baseline population would experience the interface content component. As such, general accessibility issues and user population specific accessibility issues may be determined using the evaluation model framework.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used evaluating the accessibility of interface content.

FIG. 2 illustrates a schematic block diagram of example circuitry embodying a system device that may perform various operations in accordance with some example embodiments described herein.

FIG. 3 illustrates an example flowchart for evaluating interface content for one or more user populations of interest, in accordance with some example embodiments described herein.

FIG. 4 illustrates an example flowchart for determining one or more accessibility scores for interface content components, in accordance with some example embodiments described herein.

FIG. 5 illustrates an example flowchart for training one or more models of an evaluation model framework, in accordance with some example embodiments described herein.

FIG. 6 illustrates an example evaluation model framework, as used in accordance with some embodiments described herein.

FIG. 7 illustrates an example interface content evaluation report as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

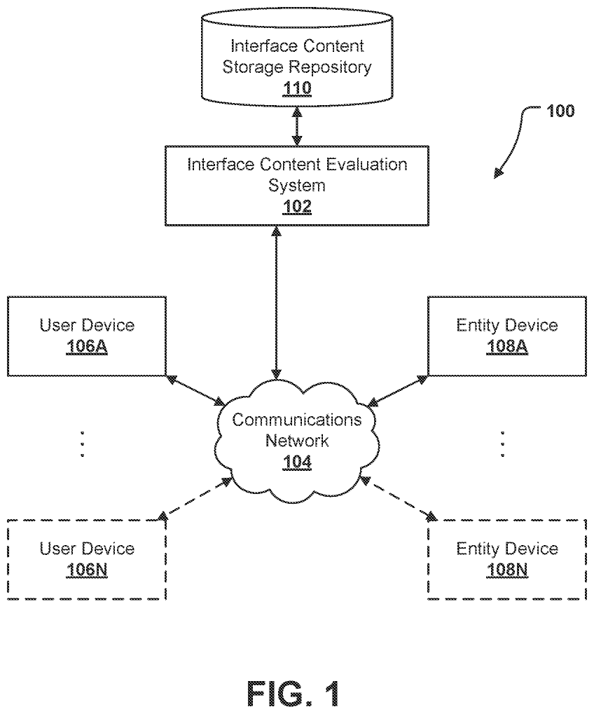

Example embodiments described herein may be implemented using any of a variety of computing devices or servers. To this end, FIG. 1 illustrates an example environment 100 within which various embodiments may operate. As illustrated, an interface content evaluation system 102 may receive and/or transmit information via communications network 104 (e.g., the Internet) with any number of other devices, such as one or more of user devices 106A-106N and/or entity devices 108A-108N.

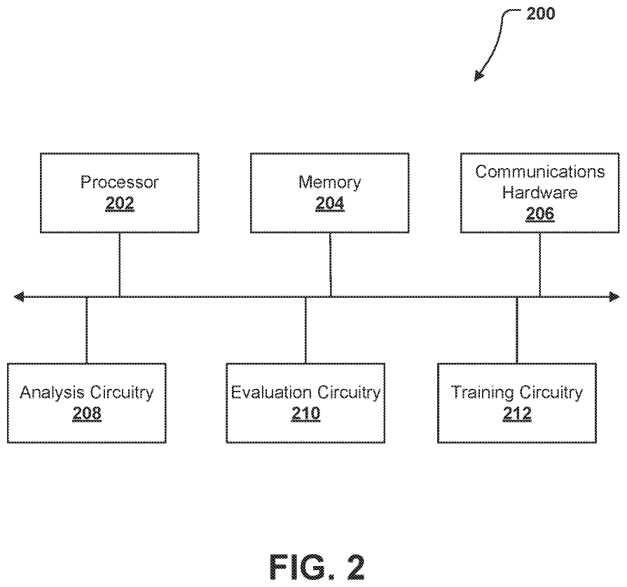

The interface content evaluation system 102 may be implemented as one or more computing devices or servers, which may be composed of a series of components. Particular components of the interface content evaluation system 102 are described in greater detail below with reference to apparatus 200 in connection with FIG. 2.

In some embodiments, the interface content evaluation system 102 further includes an interface content storage repository 110 that comprises a distinct component from other components of the interface content evaluation system 102. The interface content storage repository 110 may be embodied as one or more direct-attached storage devices (such as hard drives, solid-state drives, optical disc drives, or the like) or may alternatively comprise one or more Network Attached Storage devices independently connected to a communications network (e.g., communications network 104). In some embodiments, the interface content storage repository 110 may host the software executed to operate the interface content evaluation system 102. The interface content storage repository 110 may store information relied upon during operation of the interface content evaluation system 102, such as various models (e.g., pre-processing models, rendering models, user population models, baseline models, scoring models, and/or the like), data sets (e.g., training interface content sets, user performance training sets, and/or the like) that may be used by the interface content evaluation system 102, data and documents to be analyzed using the interface content evaluation system 102, or the like. In some embodiments, the interface content storage repository 110 may store modified interface content generated by the interface content evaluation system. In addition, the interface content storage repository 110 may store control signals, device characteristics, and access credentials enabling interaction between the interface content evaluation system 102 and one or more of the user devices 106A-106N or entity devices 108A-108N.

The one or more user devices 106A-106N and the one or more entity devices 108A-108N may be embodied by any computing devices known in the art. The one or more user devices 106A-106N and the one or more entity devices 108A-108N need not themselves be independent devices, but may be peripheral devices communicatively coupled to other computing devices.

Although FIG. 1 illustrates an environment and implementation in which the interface content evaluation system 102 interacts indirectly with a user via one or more of user devices 106A-106N and/or entity devices 108A-108N, in some embodiments users may directly interact with the interface content evaluation system 102 (e.g., via communications hardware of the interface content evaluation system 102), in which case a separate user device 106A-106N and/or entity device 108A-108N may not be utilized. Whether by way of direct interaction or indirect interaction via another device, a user may communicate with, operate, control, modify, or otherwise interact with the interface content evaluation system 102 to perform the various functions and achieve the various benefits described herein.

### Example Implementing Apparatuses

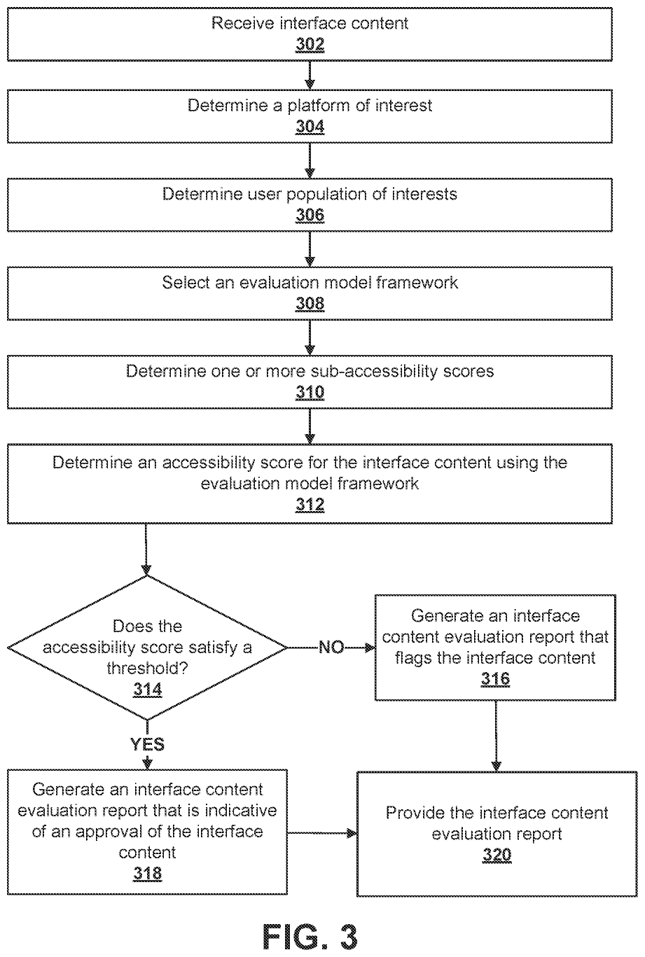

The interface content evaluation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, analysis circuitry 208, evaluation circuitry 210, and training circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, desktop application, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an analysis circuitry 208 that is configured to determine a platform of interest, determine a user population of interest, select an evaluation model framework, determine one or more sub-accessibility scores, determine an accessibility score, determine whether an accessibility score satisfies an accessibility score threshold, and generate an interface content evaluation report, and/or the like. Additionally, the analysis circuitry 208 may further be configured to identify an evaluation test for an interface content component, select a test condition, generate a baseline performance metric set, and generate a user population performance metric set. The analysis circuitry 208 may utilize processor 202, memory 204, or any other hardware component included in the apparatus 200 to perform these operations, as described in connection with FIGS. 3-5 below. The analysis circuitry 208 may further utilize communications hardware 206 to gather data from a variety of sources (e.g., user devices 106A-106N, entity device 108A-108N, or interface content storage repository 110, as shown in FIG. 1).

In addition, the apparatus 200 further comprises evaluation circuitry 210 that is configured to identify a training interface content set, receive a user response to provided training interface content, generate a user performance score, generate a user performance training set, and/or the like. The evaluation circuitry 210 may utilize processor 202, memory 204, or any other hardware component included in the apparatus 200 to perform these operations, as described in connection with FIGS. 3-5 below. The evaluation circuitry 210 may further utilize communications hardware 206 to gather data from a variety of sources (e.g., user devices 106A-106N, entity device 108A-108N, or interface content storage repository 110, as shown in FIG. 1).

In addition, the apparatus 200 further comprises training circuitry 212 that is configured to train one or more models included in the evaluation model framework. The evaluation circuitry 210 may utilize processor 202, memory 204, or any other hardware component included in the apparatus 200 to perform these operations, as described in connection with FIGS. 3-5 below. The evaluation circuitry 210 may further utilize communications hardware 206 to gather data from a variety of sources (e.g., user devices 106A-106N, entity device 108A-108N, or interface content storage repository 110, as shown in FIG. 1).

Although components 202-212 are described in part using functional language, it will be understood that the particular implementations necessarily include the use of particular hardware. It should also be understood that certain of these components 202-212 may include similar or common hardware. For example, the analysis circuitry 208, evaluation circuitry 210, training circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the analysis circuitry 208, evaluation circuitry 210, and training circuitry 212 may leverage processor 202, memory 204, or communications hardware 206 as described above, it will be understood that any of analysis circuitry 208, evaluation circuitry 210, and training circuitry 212 may include one or more dedicated processor, specially configured field programmable gate array, or application specific interface circuit to perform its corresponding functions, and may accordingly leverage processor 202 executing software stored in a memory (e.g., memory 204), or communications hardware 206 for enabling any functions not performed by special-purpose hardware. In all embodiments, however, it will be understood that analysis circuitry 208 and training circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3-5, example flowcharts are illustrated that contain example operations implemented by example embodiments described herein. The operations illustrated in FIGS. 3-5 may, for example, be performed by system device of interface content evaluation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, analysis circuitry 208, evaluation circuitry 210, training circuitry 212, and/or any combination thereof. It will be understood that user interaction with the interface content evaluation system 102 may occur directly via communications hardware 206, or may instead be facilitated by a separate entity device 108A-108N, as shown in FIG. 1, and which may have similar or equivalent physical componentry facilitating such user interaction.

### Example Operations for Evaluating Interface Content

Turning first to FIG. 3, example operations are shown for evaluating interface content for one or more user populations. As shown by operation 302, the apparatus 200 includes means, such as processor 202, memory 204, communications hardware 206, or the like, for receiving interface content. In some embodiments, communications hardware 206 may be configured to receive interface content. In particular, the communications hardware 206 may receive interface content from an entity device (e.g., any one of entity devices 108A-108N). In some embodiments, the interface content may be executable and/or may cause associated interface content components to be rendered on an associated display. Said otherwise, the interface content may be configured with software instructions that cause associated interface content components to render on a display screen. For example, interface content may be a webpage, an application page, and/or the like. In some embodiments, the interface content may further be associated with an endpoint and/or uniform resource locator (URL) that may be used to access the interface content.

In some embodiments, the communications hardware 206 may receive the interface content in response to a digital content evaluation request. A digital content evaluation request may be a request to evaluate interface content that is currently available or soon to be available on an online platform associated with apparatus 200. For example, an entity that manages apparatus 200 may have a website that includes various webpages, tools, and other digital content. The entity may have published digital content such that it is accessible or publicly available. However, a software, web developer, compliance officer etc. may wish to evaluate the interface content proactively. Alternatively, these users may wish to evaluate the interface content in response to received complaints or perceived issues with the interface content. However, it may be difficult for users experiencing these accessibility issues to articulate what interface content component is causing the issue. While such interface content may pass basic WCAG standards, the interface content or particular interface content components may be inaccessible for certain user populations. Therefore, the user (e.g., software, web developer, compliance officer, or the like) may wish to evaluate the existing interface content to understand these sometimes-nuanced accessibility issues before they occur or in a targeted manner responsive to a complaint or issue. The digital content evaluation request may be indicative for the interface content to be evaluated by apparatus 200 and an accessibility score generated for the interface content for one or more user populations of interest. In this way, the user need only provide a single instance of interface content and apparatus 200 may evaluate the interface content for its accessibility amongst different user populations.

The interface content may include any number of interface content components. In some embodiments, interface content components may be assigned an interface content component type and/or an interface content component subtype. Interface content component types may be indicative of the broader functionality the interface content component serves for the interface content. For example, an interface content component type may include a structure interface content component type, a styling interface content component type, an interactivity interface content component type, a visual interface content component type, a textual interface content component type, a navigation interface content component type, and/or a plugin interface content component type. A structure interface content component type may be assigned to interface content components (e.g., Hypertext Markup Language (HTML)) that provide the structure of the interface content components and defines various portions of the other interface content. A styling interface content component type may be assigned to interface content components (e.g., a Cascading Style Sheet (CSS)) that control the visual presentation of other interface content components (e.g., layout, colors, fonts, spacing, and the like). An interactivity interface content component may be assigned to interface content components (e.g., JavaScript) configured to handle user interactivity with some interface content components (e.g., form submissions, animations, user events such as clicking or keyboard input, or the like). A visual interface content component type may be assigned to interface content components (e.g., images, videos, and audio) of various formats (e.g., joint photographic experts group (JPG/JPEG), portable network graphics (PNG), graphics interchange format (GIF), motion picture experts group advanced video coding (MP4), web media file (WebM), and/or the like) that control visual presentation. A textual interface content component type may be assigned to interface content components that supply text information to the user. A navigation content component may be assigned to interface content components that are associated with hyperlinks to aid the user with navigating the website. A plugin interface content component type may be assigned to interface content components that may add more complex features to the website, such as slideshows, chatbots, analytics tools, or the like.

Additionally, each interface content component may be assigned an interface content component subtype that is indicative of the function of the particular interface content component within the interface content component type. For example, an interface content component that depicts a single image may be assigned an image interface content component subtype.

In some embodiments, the received interface content components may already be labelled with the interface content component type and/or interface content component subtypes. Alternatively, the interface content may be configured in accordance with a predefined structure such that the interface content component type and/or interface content component subtype may be determined by analysis circuitry 208 and/or subsequent models that process the interface content (e.g., a rendering model, a user population model, a baseline model, and/or a scoring model).

Furthermore, interface content components may be associated with one or more values, parameters, settings, configurations, and/or the like. By way of example, an interface content component may be an image and thus, may be assigned a visual interface content component type and an image interface content component subtype. The interface content component may include values for one or more pixels associated with the image. As another example, the interface content component may be a screen reader and thus, may be assigned an interactivity interface content component type and a screen reader interface content component subtype. The screen reader may include settings such as the reader tone, a reader pitch, a reader volume, a reader speed, and/or other auditory settings. As yet another example, the interface content component may be textbox text and thus, may be assigned a textual interface content component type and a textbox interface content component subtype. The textbox text may include characters that form the textbox text, font size for each text character, font style for each character, font color for each character, a font spacing between characters, and/or the like. As yet another example, the interface content component may be a CSS page structure and thus, may be assigned a styling interface content component type and CSS page interface content component subtype. The CSS page structure may include the various layout components of an HTML page, such as the position of various website components within a layout. As yet another example, the interface content component may be a HTML page structure and thus, may be assigned a structure interface content component type and HTML page interface content component subtype. The HTML page structure may include reference to one or more HTML objects or other components included on a website page.

As shown by operation 304, the apparatus 200 includes means, such as processor 202, memory 204, analysis circuitry 208, or the like, for determining a platform of interest. In some embodiments, the communications hardware 206 may also receive an indication of one or more platforms of interest from an entity device (e.g., any one of entity devices 108A-108N), such as in a digital content evaluation request. Thus, the digital content evaluation request may include an indication of one or more platforms for which interface content is to be evaluated. The inclusion of multiple platforms of interest may allow for interface content to be evaluated for accessibility for user populations across many different platforms for a single digital content evaluation request. In an instance in which multiple platforms are of interest, the analysis circuitry 208 may determine a platform of interest by selecting a platform of interest from the platforms of interest not yet associated with an accessibility score associated with a population of interest for the interface content. The analysis circuitry 208 may perform operations 304-318 for each platform of interest such that an accessibility score is determined for each user population of interest within each platform of interest. In this way, accessibility of interface content may be evaluated for both a particular platform as well as for a user population. This may be particularly useful in instances in which a user accessing digital content does not have a registered account and/or known user preferences. In such a scenario, the interface content presented to such a user may still be optimized for the particular platform used to access the digital content.

A platform of interest may correspond to a category of technology platforms that may be used to display, render, or otherwise allow access to interface content for users. Each platform may be associated with configurations, settings, parameters, options, and/or the like that describe how digital content is rendered within the particular platform. For example, a platform of interest may include a web browser, a native mobile application, and/or a desktop application. It will be appreciated that any number of platforms with various levels of granularity can be contemplated.

As shown by operation 306, the apparatus 200 includes means, such as processor 202, memory 204, analysis circuitry 208, or the like, for determining one or more user populations of interest. In some embodiments, the communications hardware 206 may also receive an indication of one or more user populations of interest from an entity device (e.g., any one of entity devices 108A-108N), such as in a digital content evaluation request. Thus, the digital content evaluation request may include an indication of one or more user populations for which interface content is to be evaluated and an accessibility score determined. The inclusion of multiple user population of interest may allow for interface content to be evaluated for multiple user populations for a single digital content evaluation request. In an instance in which multiple user populations are of interest, the analysis circuitry 208 may determine a user population of interest by selecting a user population of interest from the multiple user populations of interest not yet associated with an accessibility score for the interface content. The analysis circuitry 208 may perform operations 306-318 for each user population of interest in the multiple user populations of interest such that interface content is evaluated for each user population of interest and an accessibility score determined for each user population of interest.

In some embodiments, analysis circuitry 208 may determine a user population of interest for a particular platform of interest and may repeat this process for each platform of interest. However, it will be appreciated that alternatively, a user population of interest may first be determined, and a platform of interest may be determined subsequently such that analysis circuitry 208 determines a technology platform of interest for a particular user population of interest and may be repeated this process for each user population of interest. Said otherwise, operation 304 and 306 may occur in any order.

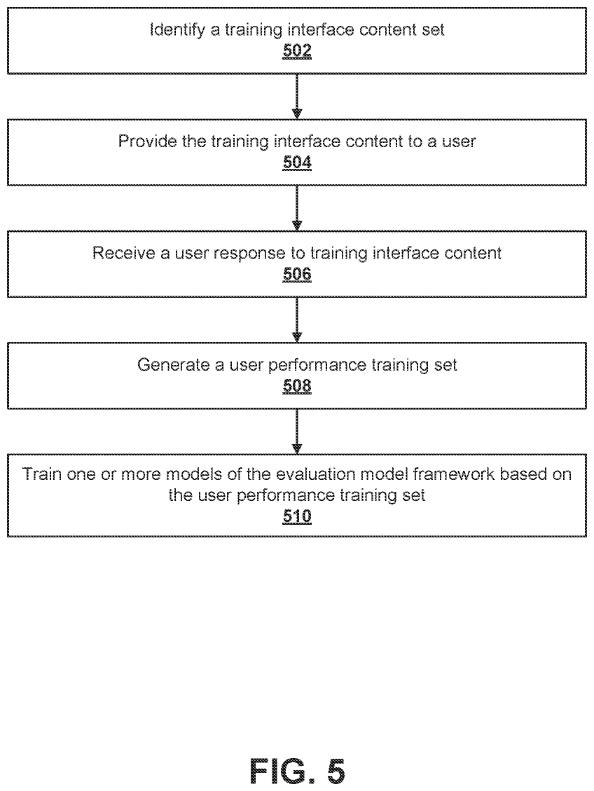

A user population of interest may correspond to a category of users that include one or more users that share similar preferences with respect to configurations, settings, parameters, options, and/or the like for digital content. It will be appreciated that any number of user populations with various levels of granularity can be contemplated. Furthermore, users included in a user population need not have a uniform medical diagnosis and may simply have similar preferences such that the individual user is included within a user population. By way of example, a user may be included in a low visibility user population due to his/her preferences that are similar to users with low visibility but may not themselves experience visual impairment. The grouping and assignment of users and user populations will be described in greater detail in FIG. 5.

As shown by operation 308, the apparatus 200 includes means, such as processor 202, memory 204, analysis circuitry 208, or the like, for selecting an evaluation model framework. In some embodiments, the analysis circuitry 208 may be configured to select an evaluation model framework from a plurality of evaluation model frameworks. The analysis circuitry 208 may select the evaluation model framework based on the selected user population of interest. In some embodiments, the evaluation model framework may be stored in an associated memory, such as a memory 204. Each stored evaluation model framework may be associated with a particular user population. For example, a stored evaluation model framework may be labelled with a corresponding user population label. Thus, the analysis circuitry 208 may select the stored evaluation model framework associated with the user population corresponding to the selected user population of interest. As described in greater detail below and in FIG. 5, the user population associated with the evaluation model framework may be indicative of the user population used to train a user population model within the evaluation model framework. Thus, the user population model may emulate a user of the user population and further, emulate how the user would perceive rendered interface content and/or interface content components.

An evaluation model framework may be an integrated environment that includes one or more models and is configured to receive interface content and an indication of the platform of interest and provide an accessibility score for the interface content. The evaluation model framework may include individual models as well as instructions, algorithms, and/or the like for using each included model. For example, an evaluation model framework a rendering model, a baseline model, a user population model, and a scoring model. Some of the individual models may be used in other evaluation model frameworks while others are exclusively used in the particular evaluation model framework. For example, the rendering model, the baseline model, and the scoring model may be used in other evaluation model frameworks associated with user populations other than the selected user population. However, the user population model included in the particular evaluation model framework may be unique and only used within this evaluation model framework. In this way, the evaluation model framework is agile and allows for the incorporation of common models used in other evaluation model frameworks. This further allows for reduced expenditure of computational resources by intelligently allowing for models with a broader applicable use to be utilized by multiple evaluation model frameworks while reserving other more nuanced models for exclusive use by a single evaluation model framework. The particular operations of the individual models will be described in more detail below.

As shown by operation 310, the apparatus 200 includes means, such as processor 202, memory 204, analysis circuitry 208, or the like, for determining one or more sub-accessibility scores. In particular, the analysis circuitry 208 may determine the one or more sub-accessibility scores using the selected evaluation model framework. A sub-accessibility score may correspond to a particular interface content component. In particular, the sub-accessibility score may be indicative of the inferred accessibility of the particular interface content component for the user population of interest.

By way of particular example, a content interface component may be an image and therefore be associated with a visual interface content component type and an image interface content component subtype. A sub-accessibility score for the interface content component may be indicative of an inferred accessibility of the image for a particular user population, such as a low-vision user population, color-blind user population, etc. Various factors may contribute to the image's accessibility, such as the color scheme used, whether the image inclusion HTML code for a text alternative of the image, the accuracy and/or descriptiveness of the text alternative, whether the image contains text, the readability of any text within the image, and/or the like.

As another example, a content interface component may be textbox text and thus, may be assigned a textual interface content component type and a textbox interface content component subtype. A sub-accessibility score for the interface content component may be indicative of an inferred accessibility of the text for a particular user population, such as a cognitively impaired user population, a low-vision user population, a color-blind user population, etc. Various factors may contribute to the text's accessibility, such as the font size for each text character, font style for each character, font color for each character, a font spacing between characters, the particular language in the text, the complexity of the language and/or individual terms, and/or the like.

As another example, a content interface component may be a video and therefore be associated with a visual interface content component type and a video interface content component subtype. A sub-accessibility score for the interface content component may be indicative of an inferred accessibility of the image for a particular user population, such as a hearing-impaired user population, a low-vision user population, a color-blind user population, etc. Various factors may contribute to the video's accessibility, such as the whether the video includes captions, whether the video includes a narration audio track, the accuracy and/or descriptiveness of the captions and/or narration audio track, the readability of any text and/or captions within the video, and/or the like.

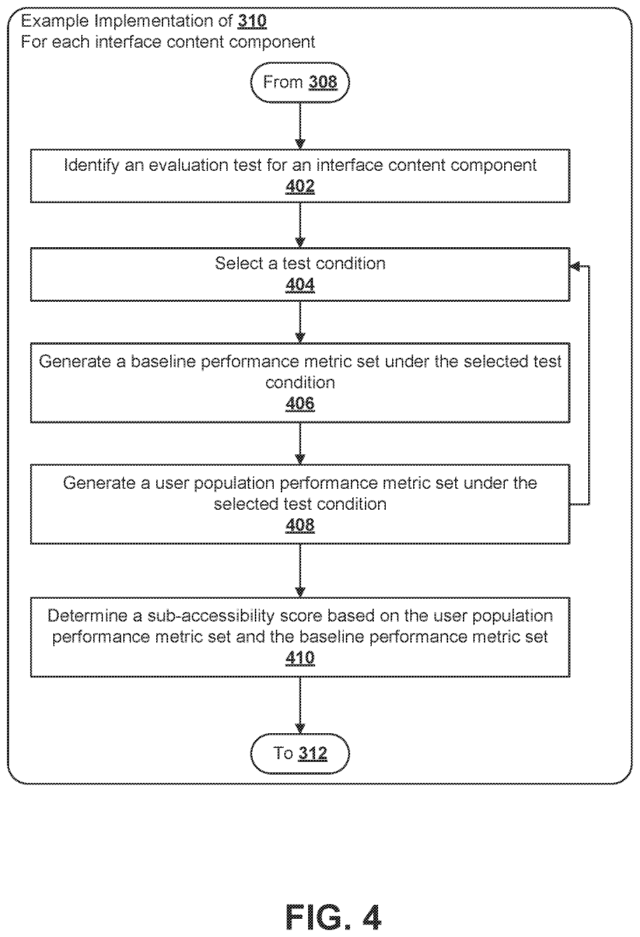

In some embodiments, operation 310 may be performed in accordance with the operations described by FIG. 4. Turning now to FIG. 4, example operations are shown for determining a sub-accessibility score for an interface content component. Each of operation 402-410 may be performed for each interface content component of the interface content.

As shown by operation 402, the apparatus 200 includes means, such as processor 202, memory 204, analysis circuitry 208, or the like, for identifying an evaluation test for an interface content component. The analysis circuitry 208 may be configured to use the evaluation model framework to identify an evaluation test to perform for a particular interface content component. In particular, a rendering model of the evaluation model framework may be configured to identify and select an evaluation test.

The rendering model may be a rules-based or a machine learning model that is configured to receive interface content and an indication of the platform of interest and provide or output rendered interface content to a user population model and a baseline model. The rendering model may further be configured with a plurality of evaluation tests. Each evaluation test may be associated with a particular interface content component type and/or interface content component subtype. Thus, the rendering model may be configured to select an evaluation test that is associated with a same interface content component type and/or interface content component subtype as the interface content component to be tested. An evaluation test may include a set of software instructions and/or operations for rendering interface content and further, describe one or more tasks to be performed by a user population model and a baseline model. The instructions may further describe one or more test conditions for which to render the interface content. The evaluation test may be configured to test the accessibility of the individual interface content component across for a user population and under various test conditions. In this way, the evaluation test may be designed to probe the accessibility of interface content components as experienced for a particular user population under various test conditions.

Once the rendering model has selected an evaluation test, it may provide the one or more tasks to the user population model and baseline model. Thus, the user population model and baseline model may be informed of the tasks they need to individually perform for the rendered interface content. A task for an evaluation test may be a request for the recipient model to perform a particular operation with respect to rendered interface content. The tasks included in an evaluation test may be dependent of the particular evaluation test. For example, for an evaluation test associated with a textbox interface content component subtype, the evaluation test may include a task to provide a text description of the textbox as interpreted and/or processed by the recipient model, provide an answer to a prompt based on an analysis of the textbox, and/or the like. The tasks included in the evaluation test may be configured to test how accessible and interpretable the rendered interface content is for a user population. As will be discussed in greater detail in operations 406 and 408, the user population model and baseline model may be configured to provide a user population performance metric set and a baseline performance metric set, respectively. These metric sets may include the model responses to the various tasks of the evaluation test and are used by a scoring model to determine a sub-accessibility score for the interface content component.

As shown by operation 404, the apparatus 200 includes means, such as processor 202, memory 204, analysis circuitry 208, or the like, for selecting a test condition. Once the analysis circuitry 208 has been used identified and determined an evaluation test for the interface content component using the rendering model of the evaluation model framework, the rendering model may further be configured to select a test condition. As described above, the evaluation test may include one or more test conditions. A test condition may describe settings, configurations, parameters, or the like for how to render the interface content. For example, a test condition may describe audio settings (e.g., volume, gain, and/or the like), visual settings (e.g., dark mode, light mode, color format, color space, and/or the like) display settings (e.g., display resolution, display orientation, layout scaling, refresh rate, and/or the like). A selected test condition may describe the various values for each of the aforementioned settings. Thus, the test condition may provide instructions to the rendering model for rendering the interface content.

Once the rendering model has selected a test condition, it may cause rendering of the interface content. The rendering model may be configured to provide rendered interface content to the user population model and the baseline model. The rendering model may be configured to provide rendered interface content in a variety of ways. In some embodiments, the rendering model may be configured to cause the rendering of the interface content on an associated display and/or speakers such that it may be captured by the user population model and/or baseline model, such as via a camera, microphone, etc. In some embodiments, the rendering model may cause text of the interface content to be rendered in various ways, such as by using a screen reader and/or a speech-to-text (STT) algorithm to present textual interface content components.

Alternatively, in some embodiments, the rendering model may generate a representation of the interface content and provide this representation as the rendered interface content. For example, the rendering model may be configured to represent the interface content and/or interface content components as vectors, arrays, lists, matrices, and/or the like. By way of particular example, the interface content may be represented as a matrix of pixel values such that the user population model and/or baseline model may be configured to process the rendered interface content and/or content components in this structured (e.g., matrix, vector, array, list, or the like) form. In some embodiments, the evaluation test may include instructions instructing the rendering model on how to provide the rendered interface content. Furthermore, the instructions may include one or more algorithms to use to generate the structured rendered interface content. For example, the rendering model may simply determine generate a matrix indicative of pixel values for the interface content and convert these pixel values to represent the pixel colors in various formats (e.g., red, green, blue (RGB) grayscale). Additionally or alternatively, the rendering model may be configured to convert certain interface content components type, such as textual interface content component types, into vectors or matrices using various techniques such as term-frequency-inverse document frequency (TF-IDF) or word embeddings techniques, such as Word2Vec or global vectors (GloVe). Other techniques may also be contemplated from transforming interface content components into structured representations.

As shown by operation 406, the apparatus 200 includes means, such as processor 202, memory 204, analysis circuitry 208, or the like, for generating a baseline performance metric set under the selected test condition. The analysis circuitry 208 may be configured to generate a baseline performance metric set using the evaluation model framework. In particular, a baseline model may be used to generate the baseline performance metric set. The baseline model may be configured to directly receive the rendered interface content from the rendering model, in an instance in which the rendered interface content is provided in a structured format (e.g., as a vector, matrix, array, list, or the like). Alternatively, the baseline model may be configured to use one or more associated devices, such as a microphone and/or or camera to capture rendered interface content that is output by the rendering model via an associated display and/or speakers. For example, a microphone may capture audio content and provide the audio to the captured audio to the baseline model. The baseline model may then use a text-to-speech (TTS) algorithm to convert the captured audio content to text.

Regardless of how the baseline model receives the rendered interface content, the baseline model may then be configured to process the rendered interface content and perform the one or more tasks received from the rendering model. In some embodiments, the baseline model is a machine learning model or deep learning model that is configured to process received tasks and rendered interface content and generate a baseline performance set that includes various responses and metrics for regarding the task performance. The baseline model may be trained to handle different forms of data (e.g., different interface content types) simultaneously. In some embodiments, the baseline model may be a neural network (e.g., a convolutional neural network (CNN), recurrent neural network (RNN), long short-term memory (LSTM), and/or the like), a vision and language model, a large language model, a series of autoencoders, a transformer model, and/or the like.

To generate the baseline performance set, the baseline model may be configured to process the one or more received tasks, either independently or simultaneously and may then process the rendered interface content in response to the task. For example, a task may include providing a text description of the rendered interface content and the baseline performance set may provide the captured TTS text. As another example, a task may be to provide a summary of text of a particular textbox within the rendered interface content and the baseline model may be configured to use one or more image processing techniques and/or natural language processing techniques to identify the requested textbox, analyze the corresponding text, and generate a text summary. As yet another example, a task may be to provide a description of a particular image and the baseline model may be configured to use image processing techniques to analyze the rendered interface content and generate a summary of the image. The baseline model may further be configured to measure one or metrics associated with the performance of a particular task, such as the time to complete the task, a start time, an end time, and/or the like. The baseline model may generate the baseline performance metric set for the test condition and may include the response to the task and the various metrics associated with performance of the task for each task in the evaluation test.

As shown by operation 408, the apparatus 200 includes means, such as processor 202, memory 204, analysis circuitry 208, or the like, for generating a user population performance metric set under the selected test condition. The analysis circuitry 208 may be configured to generate a user population performance metric set using the evaluation model framework. In particular, a user population model may be used to generate the user population performance metric set. Similar to the baseline model, the user population model may be configured to directly receive the rendered interface content from the rendering model, in an instance in which the rendered interface content is provided in a structured format (e.g., as a vector, matrix, array, list, or the like). Alternatively, the user population model may be configured to use one or more associated devices, such as a microphone and/or or camera to capture rendered interface content that is output by the rendering model via an associated display and/or speakers. For example, a microphone may capture audio content and provide the audio to the captured audio to the baseline model. The user population model may then use a text-to-speech (TTS) algorithm to convert the captured audio content to text.

Regardless of how the user population model receives the rendered interface content, the user population model may then be configured to process the rendered interface content and perform the one or more tasks received from the rendering model. In some embodiments, the user population model is a machine learning model or deep learning model that is configured to process received tasks and rendered interface content and generate a user population performance set that includes various responses and metrics for regarding the task performance. The user population model may be trained to handle different forms of data (e.g., different interface content types) simultaneously. In some embodiments, the user population model may be a neural network (e.g., a CNN, RNN, LSTM, and/or the like), a vision and language model, a large language model, a series of autoencoders, a transformer model, and/or the like.

As described in further detail in FIG. 5, the user population model may differ from the baseline model in various parameters, configurations, settings, etc. that allow the user population model to emulate a particular user from a user population. In some embodiments, the user population model may be configured to apply one or more filters, distortions, settings, and/or when processing the received rendered interface content to simulate how the rendered interface content may be perceived by a user in a particular user population. The user population model may then perform the tasks and generate the user population performance metric set. The user population model may generate the user performance metric set in a similar manner as described above in operation 406.

In some embodiments, an evaluation test may include one or more test conditions. Thus, operations 404-408 may be repeated for each test condition included in the user simulation test. In this way, the user population performance metric set and the baseline performance metric set may be updated to include performance metrics for performance of the user population model and the baseline model under the various test conditions for a given user interface content component.

As shown by operation 410, the apparatus 200 includes means, such as processor 202, memory 204, analysis circuitry 208, or the like, for determining a sub-accessibility score based on the user performance metric set and the baseline performance metric set. The analysis circuitry may further determine a sub-accessibility score using the evaluation model framework. In particular, a scoring model may determine a sub-accessibility score for the interface content component based on the user performance metric set and the baseline performance metric set. The sub-accessibility score may be indicative of an inferred accessibility of the interface content component for the user population.

The scoring model may be a machine learning model or deep learning model that is configured to analyze the user performance metric set and baseline performance metric set and generate the sub-accessibility score for the interface content component. In some embodiments, the scoring model is a neural network (e.g., a CNN, RNN, LSTM, and/or the like), a vision and language model, a large language model, a series of autoencoders, a transformer model, and/or the like. To determine the sub-accessibility score, the scoring model may determine an accuracy score for each task response from the user population model and baseline model. To do so, the rendering model may provide the scoring model with ground-truth data that is indicative of a correct response for each task. The scoring model may then determine an accuracy of a response to a task response for the baseline model from the task response included the baseline performance metric set. The scoring model may similarly determine an accuracy of a response to a task response for the user population model from the task response included the user population performance metric set. For example, in an instance a response to a task included a text description of an interface content component, the scoring model may compare the text description included in either the baseline metric set or user population metric set to a text description included in the ground-truth data. Thus, the scoring model may be configured to determine an accuracy score for each task for each as provided by each of the user population model and baseline model, independently.

In some embodiments, the scoring model may be configured to apply one or more similarity algorithms to determine an accuracy score for a task response provided by a particular model. For example, the scoring model may be configured to apply a Euclidean distance algorithm, a cosine similarity algorithm, a Jaccard similarity algorithm, a Levenshtein distance algorithm, a hamming distance algorithm, a TF-IDF algorithm, a Pearson correlation coefficient algorithm, a Spearman's rank correlation algorithm, a histogram comparison algorithm, a structural similarity index (SSIM) algorithm, a feature matching algorithm, and/or the like.

The accuracy score for a task may be indicative of whether the interface content component has accessibility issues that affect a specific user population or alternatively, whether the interface content component has more general accessibility issues. In particular, the scoring model may determine whether the accuracy scores determined for a task response satisfy an accuracy score threshold for both the baseline model and the user population model. For example, if the accuracy score for a task response for a baseline model is indicative of a low accuracy such that it fails to satisfy the accuracy score threshold, this may be indicative that the interface content component is not accessible for any user population. Thus, although the accuracy score of task responses between the user population model and baseline performance model may be similar (e.g., low accuracy), this is not indicative that the interface content component is accessible to the user population. Instead, this is indicative that the interface content component is generally inaccessible to users, including users in the user population.

The scoring model may also compare the relative accuracy score for a task response between a user population model and a baseline model. The scoring model may be configured to apply any suitable algorithm, such as any aforementioned algorithm used to determine an accuracy score and/or mathematical operations and/or logical operations to perform this comparison. Furthermore, the scoring model weigh the various metrics associated with performance of the task when determining the sub-accessibility score for the interface content component. For example, the scoring model may determine a sub-accessibility score that is indicative of a less accessible interface content component where the user population model has overall similar accessibility scores as compared to the baseline model but where the metrics associated with the task were indicative of a significantly slower performance.

The scoring model may determine an accuracy score for each task response included in an evaluation test for each test condition for the baseline model and an accuracy score for each task response included in an evaluation test for each test condition for the user population model. The scoring model may then determine the sub-accessibility score based on the accuracy score of the user population model under the various test conditions, the accuracy score of the baseline model under the various test conditions, a comparison of corresponding accuracy scores between the baseline model and the user population model, and a comparison of the metrics between the baseline model and the user population model.

It will be appreciated that operations 402-410 may be repeated for each interface content component included in the interface content. In this way, the interface content components that are included in the interface content may be individually tested for accessibility.

Returning now to FIG. 3, as shown by operation 312, the apparatus 200 includes means, such as processor 202, memory 204, analysis circuitry 208, or the like, for determining an accessibility score for the interface content using the evaluation model framework. Once the analysis circuitry 208 has determined the one or more sub-accessibility scores, the analysis circuitry 208 may determine an accessibility score using the evaluation model framework. In particular, the scoring model to determine an accessibility score for the interface content for the user population of interest and given platform of interest. In some embodiments, the scoring model may further label the accessibility score with a user population label, indicative of the user population for which the accessibility score corresponds and a platform label, indicative of a platform for which the accessibility score corresponds.

The scoring model may be configured to determine the accessibility score based on the one or more sub-accessibility scores as determined in operation 310. In some embodiments, the scoring model may receive an indication from the rendering model indicative that a current sub-accessibility score is the last sub-accessibility score to be determined. This indication may be provided with the ground-truth data. Thus, the scoring model may be configured to determine the last sub-accessibility score and then determine the overall accessibility score. The scoring model may be configured to determine the accessibility score using one or more algorithms, mathematical operations, and/or logical operations. For example, the scoring model may be configured to average the sub-accessibility scores together to determine the accessibility score. In some embodiments, the scoring model may further determine a standard deviation or variance between the sub-accessibility scores. The scoring model may then sub-accessibility scores that are outliers based on the standard deviation or variance and in some embodiments, may weight these sub-accessibility scores differently than the other sub-accessibility scores. For example, if one sub-accessibility score is indicative of a low accessibility for an interface content component, the scoring model may weight this sub-accessibility more than the other sub-accessibility scores. In this way, the accessibility score of interface content may consider anomalies within the interface content which may require special consideration or attention.

As shown by operation 314, the apparatus 200 includes means, such as processor 202, memory 204, analysis circuitry 208, or the like, for determining whether the accessibility score satisfies an accessibility score threshold. The analysis circuitry 208 may then determine whether the accessibility score satisfies an accessibility score threshold. The accessibility score threshold may be a pre-set value, which may be configured by a software developer or administrator associated with apparatus 200.

In an instance in which the accessibility score is fails to satisfy the accessibility score threshold, the process proceeds to operation 316. As shown by operation 316, the apparatus 200 includes means, such as processor 202, memory 204, analysis circuitry 208, or the like, for generating an interface content evaluation report that flags the interface content for the user population group of interest. The analysis circuitry 208 may generate an interface content evaluation report in response to receiving the interface content. In an instance the analysis circuitry 208 determines that an accessibility score fails to satisfy an accessibility score threshold, the analysis circuitry may generate the interface content evaluation report to flag the interface content for the user population of interest. Thus, end users viewing the interface content evaluation report may be made aware of potential issues a user population may experience with the interface content.

In an instance in which the accessibility score satisfies the accessibility score threshold, the process proceeds to operation 318. As shown by operation 318, the apparatus 200 includes means, such as processor 202, memory 204, analysis circuitry 208, or the like, for generating an interface content evaluation report that is indicative of an approval of the interface content for the user population group of interest. The analysis circuitry 208 may generate an interface content evaluation report in response to receiving the interface content. In an instance the analysis circuitry 208 determines that an accessibility score satisfies an accessibility score threshold, the analysis circuitry may generate the interface content evaluation report to be indicative of an approval of the interface content for the user population group of interest. Thus, end users viewing the interface content evaluation report may be made aware of potential issues a user population may experience with the interface content.

As shown by operation 320, the apparatus 200 includes means, such as processor 202, memory 204, communications hardware 206, analysis circuitry 208, or the like, for providing the interface content evaluation report. In some embodiments, the communications hardware 206 may be configured to provide the interface content evaluation report to one or more entity device (e.g., any one of entity devices 108A-108N). For example, the communications hardware 206 may provide the interface content evaluation report to the entity device which provided the interface content.

In some embodiments, the analysis circuitry 208 may generate the interface content evaluation report to additionally include the one or more sub-accessibility scores as well. In some embodiments, the analysis circuitry 208 may include a flag for any of the sub-accessibility scores. In this way, the interface content evaluation report may further be indicative of the particular interface content components that were identified as having accessibility issues for the user population of interest.

Furthermore, the analysis circuitry 208 may include additional accessibility scores, accessibility sub-scores, and/or the like for the additional populations of interest and/or platforms of interest. In this way, the interface content evaluation report may be indicative of an accessibility for multiple user populations of interest and across various platforms of interest.

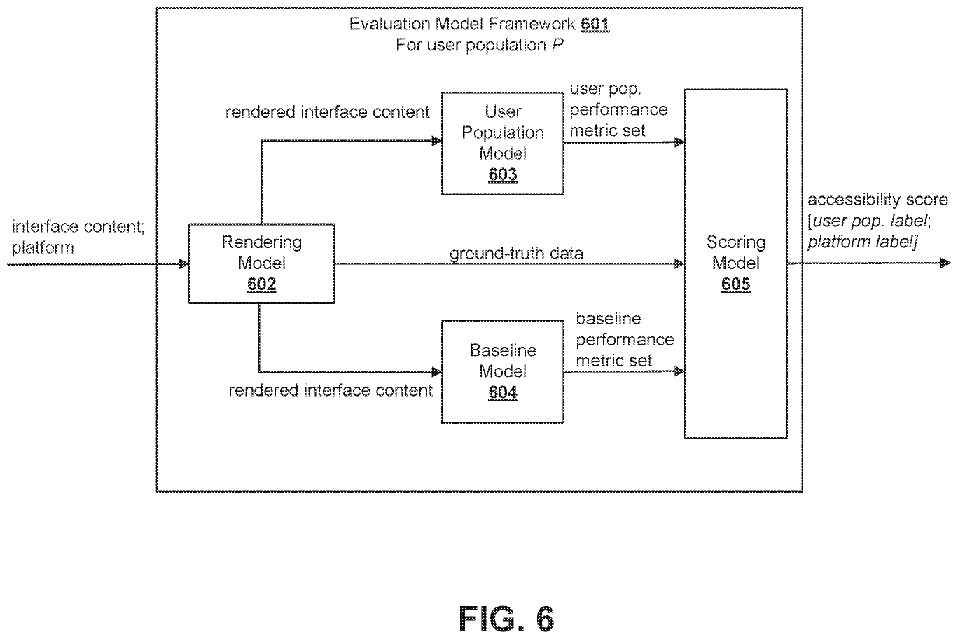

Turning to FIG. 6, an example evaluation model framework 601 is shown. The evaluation model framework 601 may be associated with a user population P. As shown in FIG. 6, the evaluation model framework 601 may include a rendering model 602, a user population model 603, a baseline model 604, and a scoring model 605. As shown in FIG. 6, the rendering model 602 may receive the interface content and platform of interest. The rendering model 602 may further identify and select an evaluation test for an interface content component. The rendering model 602 may provide an indication of the one or more tasks for the evaluation test to the user population model 603 and the baseline model 604. Additionally, the rendering model 602 may render and/or provide rendered interface content to the user population model 603 and the baseline model 604 and may further provide ground-truth data to the scoring model 605. The user population model 603 may process the rendered interface content and apply one or more filters, settings, configurations, etc. The user population model 603 may further process the altered rendered interface content and generate a response to each task as well as various metrics to generate the user population performance metric set. The baseline model 604 may process the rendered interface content and generate a response to each task as well as various metrics to generate the baseline performance metric set. The user population model 603 may provide the user population performance metric set to the scoring model 605 and the baseline model may provide the baseline performance metric set to the scoring model 605. The scoring model 605 may be configured to analyze the user population performance metric set and baseline performance metric set to generate a sub-accessibility score for the interface content component.

The above-described process may be repeated for different test conditions and for each interface content component. Once the scoring model 605 receives an indication of a last or final interface content component, it may determine the accessibility score based on the one or more sub-accessibility scores. In some embodiments, the scoring model 605 may further label the accessibility score with a user population label, indicative of the user population for which the accessibility score corresponds and a platform label, indicative of a platform for which the accessibility score corresponds.

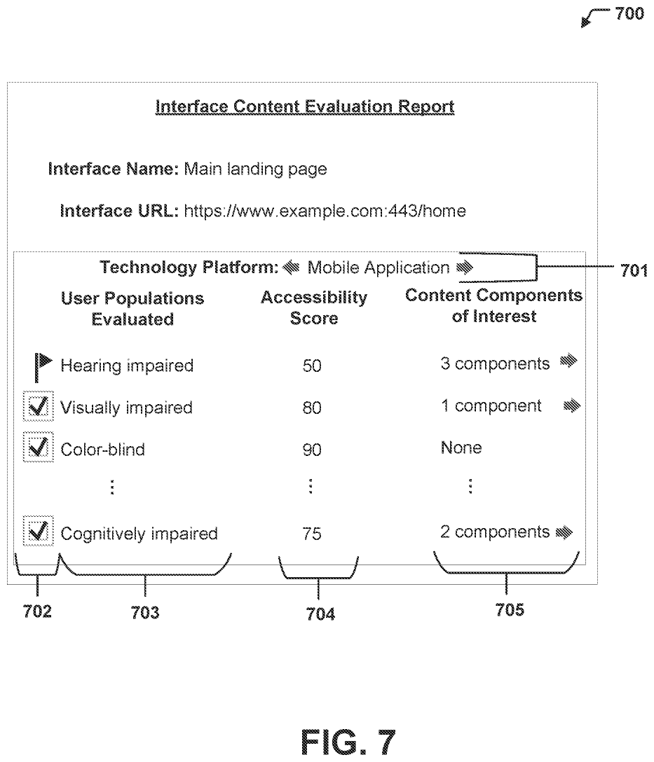

Turning now to FIG. 7, an example graphic user interface (GUI) depicting an interface content evaluation report is illustrated. As noted previously, a user may interact with the interface content evaluation system 102 by directly engaging with communications hardware 206 of an apparatus 200. In such an embodiment, the GUI shown in FIG. 7 may be displayed to a user by the apparatus 200. Alternatively, a user may interact with the interface content evaluation system 102 using a separate entity device (e.g., any of entity devices 108A-108N, as shown in FIG. 1), which may communicate with the interface content evaluation system 102 via communications network 104. In such an embodiment, the GUI shown in FIG. 7 may be displayed to the user by the entity device or via an associated display.

FIG. 7 depicts an example interface content evaluation report 700. As shown in FIG. 7, the example interface content evaluation report 700 includes one or more accessibility scores 704 that each corresponds to a user population 703. Additionally, the interface content evaluation report 700 includes an indication of one or more interface content components of interest 705. The one or more interface content components of interest 705 may be determined based on a sub-accessibility score associated with the interface content component. Furthermore, the interface content evaluation component includes an indication 702 of whether the interface content is approved or flagged for each user population 703. The interface content evaluation report 700 further includes an indication of platform 701 for which the accessibility score is generated.

Example Operations for Training Models within an Evaluation Model Framework

Turning to FIG. 5, example operations are shown for training one or more models included in an evaluation model framework.

As shown by operation 502, the apparatus 200 includes means, such as processor 202, memory 204, evaluation circuitry 210, or the like, for identifying a training interface content set. In some embodiments, the evaluation circuitry 210 may identify a training interface content set. A training interface content set may include a plurality of training interface content. Training interface content may include one or more training interface content components. The structure of training interface content may be similar to the interface content described in FIGS. 3-4. Additionally, the structure and/or format of the training interface content components may be similar to the interface content components described in FIGS. 3-4.

Additionally, each training interface content includes at least one unique training interface content component. In this way, each training interface content included in the training interface content set is unique in at least one respect. This may allow for variability within the individual training interface content. As will be described in greater detail below, this variability allows for a robust user performance training set that may be used to train various models of the evaluation model framework. Additionally, this variability allows the models to infer which interface content components affect the accessibility of interface content and the magnitude of the impact of interface content components. The training interface content component differences also may reveal trends or other patterns of user preferences for interface content components within user populations.

In some embodiments, the training interface content is generated manually by one or more users. In some embodiments, the training interface content is automatically generated using a training interface content generation models. A training interface content generation model may be a machine learning model that is configured to receive an initial training interface content with training interface content components and modify one or more values, parameters, settings, configurations, and/or the like for at least one training interface content component to generate another training interface content. In some embodiments, the training interface content generation model is a machine-learning model, such as a GAN. The training interface content generation model may allow training interface content to be generated in a way that reduces the manual burden on users for manually modifying individual training interface content components.

As shown by operation 504, the apparatus 200 includes means, such as processor 202, memory 204, communications hardware 206, evaluation circuitry 210, or the like, for providing the training interface content to a user. In some embodiments, the evaluation circuitry 210 may provide one or more training interface content to the communications hardware 206. The communications hardware 206 may provide the training interface content to a user device (e.g., any one of user devices 106A-106N).

In some embodiments, the communications hardware 206 may provide two or more training interface content to the user device at one time. This may cause the provided training interface content to be rendered or displayed to the user via the user device and/or another associated display.

Alternatively, the communications hardware 206 may provide only a single training interface content at a time. In some embodiments, the evaluation circuitry 210 may additionally provide a test prompt to the user. The test prompt may relate to the provided training interface content. For example, the test prompt may provide instructions to the user that direct them to perform a task. By way of particular example, the test prompt may direct the user to select a first navigation link (e.g., corresponding to a navigation interface content component type). The test prompt may be rendered on the user device such that the user may read the test prompt and/or may be audibly output to the user via the user device.

Additionally, the user provided with the training interface content may be associated with a user preference set. The user preference set may be indicative of one or more known user preferences for the user. A user preference may be a configuration, setting, parameter, option, and/or the like that is associated with an inferred preferred preference for the corresponding user. Additionally, the user preference set may be indicative of one or more impairments, difficulties, disabilities and/or the like of the user. For example, the user preference set may be indicative of a user preference on using a screen reader (e.g., enabled or not enabled), audio settings for a screen reader if enabled (e.g., a preferred audio gain, audio volume, audio speed, audio pitch, audio tone, and/or the like). Alternatively, a user may be unsure of his/her preferences and the user preference set may instead include only known impairments, difficulties, disabilities, etc. For example, a user preference set may be indicative that the user has low vision sensitivity. However, the user may be unsure of what visual settings he/she prefers.

Furthermore, the user may be provided the training interface content on a particular platform (e.g., web browser, mobile application, desktop application, and/or the like). The evaluation circuitry 210 may additionally determine the type of platform to which the training interface content is provided.

As shown by operation 506, the apparatus 200 includes means, such as processor 202, memory 204, communications hardware 206, evaluation circuitry 210, or the like, for receive a user response to the provided training interface content. Once the training interface content is provided to the user via a user device (e.g., any one of user devices 106A-106N), the communications hardware 206 may receive a user response from the user via the user device. The user response may be provided in response to detection of user input received from the user.

In some embodiments, the user response may be a selection of at least one training interface content from the user who is presented with two or more training interface content. For example, the user may be presented with two or more training interface content and the test prompt may direct the user to select the displayed training interface content they prefer. The user may then provide user input to select (e.g., click, tap, audibly select, and/or the like) the displayed training interface content option that the user prefers. In some embodiments, the user response may be indicative of multiple selections of training interface content in an instance in which the user was presented with multiple rounds of training interface content presentation.

In some embodiments, the user response may be one or more user inputs that the user made in order to attempt to satisfy the test prompt. The user response may additionally indicate the time window from the time the test prompt was presented to the user to when the user performed the requested action. Thus, the user response may include any erroneous user inputs, which may indicate the user experienced difficulty when attempting to perform the requested test prompt. For example, if the navigation interface content components are too close together, the user may accidentally select an incorrect navigation interface content component instead of the desired navigation interface content component. Additionally, the time window may be indicative of the level of complexity experienced by the user when navigating the training interface content to perform the test prompt. As another example, the user may experience difficult completing the test prompt because the training interface content was unclear and thus, the time window for completion may be a longer duration than an expected duration. In some embodiments, a time window threshold may also be exceeded such that the user response may indicate that the user failed to complete the test prompt within the time window threshold. These difficulties may in some cases, be attributed to accessibility difficulties experienced by the user with respect to the particular training interface content. Additionally, or alternatively, these difficulties may be attributed or compounded by the particular platform used to access the training interface content.

Additionally, in some embodiments, the user response may include user feedback with respect to the training interface content. The user feedback may be indicative of user preferences with respect to the training interface content, such as user sentiment (e.g., positive, negative, neutral) to various training interface content components. In this way, the user may provide his/her own feedback in the form of selection of predefined feedback options or as freeform user feedback.

As shown by operation 508, the apparatus 200 includes means, such as processor 202, memory 204, communications hardware 206, evaluation circuitry 210, or the like, for generating a user performance training set. Once the user response has been received, the evaluation circuitry 210 may generate a user performance training set. The user performance training set may include the training interface content, the user preference set corresponding to the user, the platform used, and the user response received from the user. In some embodiments, the user performance training set may further include the one or more corresponding test prompts.

In some embodiments, the evaluation circuitry 210 may store the user performance training set in an associated storage, such as memory 204. The user performance training set may be accessible from the associated storage such that it may be subsequently used to train one or more models, such as the user population model.

As shown by operation 510, the apparatus 200 includes means, such as processor 202, memory 204, training circuitry 212, or the like, for training one or more models included in the evaluation model framework based on the user performance training set. In some embodiments, the training circuitry 212 may be configured to access the user performance training set along with one or more other user performance training sets associated with other users and train one or more models of the evaluation model framework based on the user performance training sets. In particular, the training circuitry 212 may provide the user performance training sets to an untrained user population model such that it may be trained to optimize one or more parameters based on the user performance training sets.

In some embodiments, the training circuitry 212 may be configured to determine one or more user populations based on the user performance training sets. The one or more platforms may be a defined set of known platforms such that this clustering is not needed for platforms. In particular, the training circuitry 212 may be configured to determine one or more user populations and a corresponding user population preference set for each user population. A user population preference set may be include one or more user population preferences. A user population preference may be a configuration, setting, parameters, options, and/or the like that are associated with an inferred preferred preference for a corresponding user population. In particular, a user population preference set may be representative of preferred configurations, settings, parameters, etc. for users included within a particular user population. Although illustrative examples are provided herein, it will be appreciated that any number of user populations with various levels of granularity can be contemplated. Furthermore, users included in a user population need not have a uniform medical diagnosis and may simply have similar preferences such that the individual user is included within a user population. By way of example, a user may be included in a low visibility user population due to his/her preferences that are similar to users with low visibility but may not themselves experience visual impairment.

In some embodiments, the training circuitry 212 may be configured to determine one or more user populations by clustering users based on his/her user preferences and/or user responses. The training circuitry 212 may be configured to use any suitable clustering algorithm to determine the one or more user populations, such as K-means clustering, hierarchical clustering, density-based spatial clustering of applications with noise (DBSCAN), mean shift clustering, spectral clustering, Gaussian mixture model (GMM), ordering points to identify the clustering structure (OPTICS), and/or the like. In this way, the training circuitry 212 may be configured to define user populations in a flexible manner that takes into consideration explicit user preferences (e.g., as indicated by the user preference set) and inferred user preferences (e.g., as indicated based on the user response). In this way, users may be assigned into a user population based on user preference rather than based on a uniform medical diagnosis. This allows for flexibility in the user population and results in an improved and accessible modified interface content for all users.

Once the training circuitry 212 has determined the one or more user populations, the training circuitry 212 may provide select user performance training sets to be used to train at least a user population model and a baseline model. In some embodiments, only user performance training sets associated with a specific user population may be used to train the user population model. In this way, the user population model may be trained on one user population such that it may emulate the particular user population. In some embodiments, the baseline population model may be trained using a default user population. A default user population may correspond to users that have configuration, setting, parameter, options and/or the like that are preferred by a majority of users. In some embodiments, the training circuitry may analyze a particular user preference across various users and/or user populations to determine the most preferred configuration, setting, parameter, option, etc. for the user preference and may assign this as the default user preference.

FIGS. 3-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved user accessibility of digital content. Example embodiments thus provide tools that overcome the problems faced by conventional accessibility evaluation standards that fail to take into account user preferences or distinguish between digital content presented on different technology platforms. As such, example embodiments described herein do away with the conventional one-size-fits-all approach of conventional standards and allow for the evaluation of interface content that is considerate of preferences of a particular user population. Furthermore, example embodiments described herein contemplate evaluating interface content for various technology platforms (e.g., web content, native mobile applications, desktop applications, etc.). In this way, the interface content may be further be evaluated for its accessibility on a particular the technology platform.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for evaluating interface content for a target user population, the method comprising:
receiving, by communications hardware, the interface content comprising one or more interface content components;
determining, by analysis circuitry, a user population of interest;
selecting, by the analysis circuitry, an evaluation model framework based on the user population of interest;
determining, by the analysis circuitry and using the evaluation model framework, an accessibility score for the interface content based on the one or more interface content components;
determining, by the analysis circuitry, whether the accessibility score satisfies an accessibility score threshold; and
providing, by the communications hardware, an interface content evaluation report, wherein (a) the interface content evaluation report flags the interface content for the user population of interest in an instance in which the accessibility score fails to satisfy the accessibility score threshold and (b) the interface content evaluation report is indicative of an approval of the interface content for the user population of interest in an instance in which the accessibility score satisfies the accessibility score threshold.

2. The method of claim 1, further comprising:
determining, by the analysis circuitry, a platform of interest, wherein determining the accessibility score for the interface content is further based on the platform of interest.

3. The method of claim 1, further comprising;
determining, by the analysis circuitry and using the evaluation model framework, one or more sub-accessibility scores, wherein (a) a sub-accessibility score corresponds to an interface content component of the one or more interface content components and (b) the accessibility score is based on the one or more sub-accessibility scores.

4. The method of claim 1, further comprising:
identifying, by the analysis circuitry and using the evaluation model framework, an evaluation test for an interface content component based on an interface content component type, wherein the evaluation test comprises one or more tasks to be performed and one or more test conditions; and
determining, by the analysis circuitry and using the evaluation model framework, a sub-accessibility score for the interface content component based on one or more user population performance metrics, wherein the one or more user population performance metrics are determined based on an inferred accessibility of the interface content component for the user population of interest under the one or more test conditions.

5. The method of claim 4, further comprising:
selecting, by the analysis circuitry and using the evaluation model framework, a test condition from the one or more test conditions;
generating, by the analysis circuitry and using the evaluation model framework, a baseline performance metric set under the selected test condition; and
generating, by the analysis circuitry and using the evaluation model framework, a user population performance metric set under the selected test condition, wherein determining the sub-accessibility score for the interface content component is based on a comparison of the baseline performance metric set to the user population performance metric set.

6. The method of claim 1, further comprising:
identifying, by evaluation circuitry, a training interface content set comprising a plurality of training interface content, wherein (a) each training interface content comprises one or more training interface content components and (b) each training interface content comprises at least one unique training interface content component;
providing, by the communications hardware, training interface content to a user, wherein the user is associated with the user population; and
receiving, by the communications hardware, a user response to the provided training interface content.

7. The method of claim 6, further comprising:
generating, by the evaluation circuitry, a user performance training set comprising (i) the training interface content, (ii) the user population, and (iii) the user response; and
training, by training circuitry, one or more models included in the evaluation model framework based on the user performance training set.

8. An apparatus for evaluating interface content for a target user population, the apparatus comprising:
communications hardware configured to receive the interface content comprising one or more interface content components; and
analysis circuitry configured to:
determine a user population of interest,
select an evaluation model framework based on the user population of interest,
determine, using the evaluation model framework, an accessibility score for the interface content based on the one or more interface content components, and
determine whether the accessibility score satisfies an accessibility score threshold;
wherein the communications hardware is further configured to provide an interface content evaluation report, wherein (a) the interface content evaluation report flags the interface content for the user population of interest in an instance in which the accessibility score fails to satisfy the accessibility score threshold and (b) the interface content evaluation report is indicative of an approval of the interface content for the user population of interest in an instance in which the accessibility score satisfies the accessibility score threshold.

9. The apparatus of claim 8, wherein the analysis circuitry is further configured to determine a platform of interest, wherein determining the accessibility score for the interface content is further based on the platform of interest.

10. The apparatus of claim 8, wherein the analysis circuitry is further configured to determine, using the evaluation model framework, one or more sub-accessibility scores, wherein (a) a sub-accessibility score corresponds to an interface content component of the one or more interface content components and (b) the accessibility score is based on the one or more sub-accessibility scores.

11. The apparatus of claim 8, wherein the analysis circuitry is further configured to:
identify, using the evaluation model framework, an evaluation test for an interface content component based on an interface content component type, wherein the evaluation test comprises one or more tasks to be performed and one or more test conditions; and
determine, using the evaluation model framework, a sub-accessibility score for the interface content component based on one or more user population performance metrics, wherein the one or more user population performance metrics are determined based on an inferred accessibility of the interface content component for the user population of interest under the one or more test conditions.

12. The apparatus of claim 11, wherein the analysis circuitry is further configured to:
select, using the evaluation model framework, a test condition from the one or more test conditions;
generate, using the evaluation model framework, a baseline performance metric set under the selected test condition; and
generate, using the evaluation model framework, a user population performance metric set under the selected test condition, wherein determining the sub-accessibility score for the interface content component is based on a comparison of the baseline performance metric set and the user population performance metric set.

13. The apparatus of claim 8, further comprising evaluation circuitry configured to identify a training interface content set comprising a plurality of training interface content, wherein (a) each training interface content comprises one or more training interface content components and (b) each training interface content comprises at least one unique training interface content component;
wherein the communications hardware is further configured to:
provide training interface content to a user, wherein the user is associated with the user population, and
receive a user response to the provided training interface content.

14. The apparatus of claim 13, wherein the evaluation circuitry is further configured to:
generate a user performance training set comprising (i) the training interface content, (ii) the user population, and (iii) the user response,
wherein the apparatus further comprises training circuitry configured to train one or more models included in the evaluation model framework based on the user performance training set.

15. A computer program product for evaluating interface content for a target user population, the computer program product comprising at least one non-transitory computer-readable storage medium storing software instructions that, when executed, cause an apparatus to:
receive the interface content comprising one or more interface content components;
determine a user population of interest;
select an evaluation model framework, based on the user population of interest;
determine, using the evaluation model framework, an accessibility score for the interface content based on the one or more interface content components;
determine whether the accessibility score satisfies an accessibility score threshold; and
provide an interface content evaluation report, wherein (a) the interface content evaluation report flags the interface content for the user population of interest in an instance in which the accessibility score fails to satisfy the accessibility score threshold and (b) the interface content evaluation report is indicative of an approval of the interface content for the user population of interest in an instance in which the accessibility score satisfies the accessibility score threshold.

16. The computer program product of claim 15, wherein the software instructions, when executed, further cause the apparatus to determine a platform of interest, wherein determining the accessibility score for the interface content is further based on the platform of interest.

17. The computer program product of claim 15, wherein the software instructions, when executed, further cause the apparatus to determine, using the evaluation model framework, one or more sub-accessibility scores, wherein (a) a sub-accessibility score corresponds to an interface content component of the one or more interface content components and (b) the accessibility score is based on the one or more sub-accessibility scores.

18. The computer program product of claim 15, wherein the software instructions, when executed, further cause the apparatus to:
identify, using the evaluation model framework, an evaluation test for an interface content component based on an interface content component type, wherein the evaluation test comprises one or more tasks to be performed and one or more test conditions; and
determine, using the evaluation model framework, a sub-accessibility score for the interface content component based on one or more user population performance metrics, wherein the one or more user population performance metrics are determined based on an inferred accessibility of the interface content component for the user population of interest under the one or more test conditions.

19. The computer program product of claim 18, wherein the software instructions, when executed, further cause the apparatus to:
select, using the evaluation model framework, a test condition from the one or more test conditions;
generate, using the evaluation model framework, a baseline performance metric set under the selected test condition; and
generate, using the evaluation model framework, a user population performance metric set under the selected test condition, wherein determining the sub-accessibility score for the interface content component is based on a comparison of the baseline performance metric set and the user population performance metric set.

20. The computer program product of claim 15, wherein the software instructions, when executed, further cause the apparatus to:
identify a training interface content set comprising a plurality of training interface content, wherein (a) each training interface content comprises one or more training interface content components and (b) each training interface content comprises at least one unique training interface content component;
provide training interface content to a user, wherein the user is associated with the user population; and
receive a user response to the provided training interface content.
